(19) United States
(12) Patent Application Publication
(10) Pub. No.: US 2022/0327481 A1
(43) Pub. Date: Oct. 13, 2022

(54) OPERATING METHOD FOR ELECTRONIC APPARATUS FOR MANAGING ORDER INFORMATION AND ELECTRONIC APPARATUS SUPPORTING THEREOF

(71) Applicant: Coupang Corp., Seoul (KR)

(72) Inventor: Byoung Yong Park, Seoul (KR)

(21) Appl. No.: 17/243,076

(22) Filed: Apr. 28, 2021

(30) Foreign Application Priority Data
Apr. 7, 2021 (KR) 10-2021-0045372

(51) Int. Cl. G06Q 10/08

(52) U.S. Cl. CPC G06Q 10/08345; G06Q 10/0836

(57) ABSTRACT

Disclosed is a method of managing order information of an electronic apparatus, the method including obtaining an order request including information on or regarding an item and information on a supplier of the item, identifying a type of the supplier based on the information on the supplier, when the type of the supplier is a first type, generating, in response to the order request, first order information for supplying the item from the supplier to a first business operator related to the electronic apparatus, when the type of the supplier is a second type, generating, in response to the order request, second order information for supplying the item from the supplier to a second business operator and third order information for supplying the item from the second business operator to the first business operator, and providing at least part of the generated order information.

### TECHNICAL FIELD

The following descriptions relate to a method and an apparatus for managing order information, and more particularly, to a method for managing order information according to a type of supplier and an electronic apparatus thereof.

### DESCRIPTION OF THE RELATED ART

With the development of electronic technology, e-commerce has grown as a field of shopping. Customers can purchase items online without going to a shopping mall or market in person, and items purchased online are delivered to the delivery address requested by the customer.

The order information management system for the above e-commerce service may be operated to effectively manage service providers and item suppliers for more effective service provision. For example, in order to respond to an item purchase request from a purchaser, the order information management system determines the supplier in consideration of the characteristics of the order (e.g., delivery address, inventory at the order center, etc.) and may assign (allocate) orders related to item supply.

In this regard, related prior documents such as KR20070080012A may be referred.

### SUMMARY

### Technical Goals

An aspect of the present disclosure is to generate order information differently depending on the type of supplier by an electronic apparatus for managing order information to facilitate management convenience for suppliers and supply items.

The technical aspects of the present disclosure are not limited to those mentioned above, and other aspects that are not mentioned will be clearly understood by those skilled in the art to which the present disclosure pertains from the following description.

### Technical Solutions

Various example embodiments may provide an operating method of an electronic apparatus for managing order information and an electronic apparatus supporting the same.

According to an aspect, there is provided a method of managing order information of an electronic apparatus, the method including obtaining an order request including information on or regarding an item and information on a supplier of the item, identifying a type of the supplier based on the information on the supplier, when the type of the supplier is a first type, generating, in response to the order request, first order information for supplying the item from the supplier to a first business operator related to the electronic apparatus, when the type of the supplier is a second type, generating, in response to the order request, second order information for supplying the item from the supplier to a second business operator and third order information for supplying the item from the second business operator to the first business operator, and providing at least part of the generated order information, in which identification information of the second order information and identification information of the third order information are at least partially identical.

In an example embodiment, an order number for the item included in the identification information of the second order information and an order number for the item included in the identification information of the third order information may be the same.

In an example embodiment, an identification number included in the identification information of the second order information and an identification number included in the identification information of the third order information may be different.

In an example embodiment, information on a storage location of the item included in the second order information and information on a storage location of the item included in the third order information may be the same.

In an example embodiment, the generated order information may include information on a supply date of the item and information on a fulfillment center for supply of the item.

In an example embodiment, the first business operator may be a business operator related to a service provided through the electronic apparatus, and the second business operator may be a business operator that manages supply of the item through the supplier for the first business operator.

In an example embodiment, when the type of the supplier is the second type, the information on the supplier may include information on the second business operator.

In an example embodiment, the second order information may include information on a price at which the item is supplied from the supplier to the second business operator, and the third order information may include information on a price at which the item is supplied from the second business operator to the first business operator.

In an example embodiment, the information on the item may be identically included in the second order information and the third order information.

In an example embodiment, the third order information may be confirmed when the second order information is confirmed by a first input of the supplier corresponding to the second order information.

In an example embodiment, the method may further includes obtaining a release request including identification information of specific order information and information related to release of an item supplied from the second type of supplier, identifying a supplier subject to release corresponding to the release request based on the identification information of the specific order information, generating, based on the identification information of the specific order information, first release information for releasing the supplied item from the first business operator to the second business operator and second release information for releasing the supplied item from the second business operator to the supplier subject to release, and providing the first release information and the second release information.

In an example embodiment, a release number for the supplied item included in identification information of the first release information and a release number for the supplied item included in identification information of the second release information may be the same.

In an example embodiment, the supplier subject to release may be the supplier, and the same release number may correspond to the order number identically included in the identification information of the second order information and the identification information of the third order information.

In an example embodiment, release reason information for the supplied item included in the first release information and release reason information for the supplied item included in the second release information may be different.

According to another aspect, there is provided an electronic apparatus for managing order information including a processor and one or more memories storing one or more instructions, in which, when executed, the one or more instructions control the processor to perform obtaining an order request including information on an item and information on a supplier of the item, identifying a type of the supplier based on the information on the supplier, when the type of the supplier is a first type, generating, in response to the order request, first order information for supplying the item from the supplier to a first business operator related to the electronic apparatus, when the type of the supplier is a second type, generating, in response to the order request, second order information for supplying the item from the supplier to a second business operator and third order information for supplying the item from the second business operator to the first business operator, and providing at least part of the generated order information, and it may be characterized in that identification information of the second order information and identification information of the third order information are at least partially identical.

According to yet another aspect, there is provided a user apparatus for outputting order information including a processor and one or more memories storing one or more instructions, in which, when executed, the one or more instructions control the processor perform receiving, from a user, an order request including information on an item and information on a supplier of the item, transmitting the order request to a server apparatus, receiving, from the server apparatus, at least part of order information in response to the order request, and outputting the at least part of the order information, and it may be characterized in that, when the type of the supplier is a first type, the order information includes first order information for supplying the item from the supplier to a first business operator related to an electronic apparatus, when the type of the supplier is a second type, the order information includes second order information for supplying the item from the supplier to a second business operator and third order information for supplying the item from the second business operator to the first business operator, and identification information of the second order information and identification information of the third order information are at least partially identical.

The various example embodiments of the present disclosure described above are only some of the example embodiments of the present disclosure, and a variety of example embodiments reflecting the technical aspects of the various example embodiments of the present disclosure may be derived and understood by those skilled in the art to which the present disclosure pertains based on the detailed description to be described below.

### Effects

The present disclosure enables easy management of one or more order information for suppliers and supply items by providing a method of generating the order information differently depending on the type of supplier and managing the order information through identification information.

The effects of the present disclosure are not limited to the effects mentioned above, and other effects not mentioned will be clearly understood by those skilled in the art from the following description.

### BRIEF DESCRIPTION OF THE DRAWINGS

FIG. 1 is a diagram illustrating an order information management system in which an operating method of an electronic apparatus for managing order information according to various example embodiments may be implemented.

FIG. 2 is a diagram illustrating configurations of a server device and a user device according to various example embodiments.

FIG. 3 is a diagram illustrating an operating method of an electronic apparatus for managing order information according to various example embodiments.

FIG. 4 is a diagram illustrating an operating method of an electronic apparatus for managing release information according to various example embodiments.

FIG. 5 is a diagram illustrating an example in which a user device 200 outputs order information to a user.

FIG. 6 is a diagram illustrating another example in which a user device 200 outputs order information to a user.

FIG. 7 is a diagram illustrating an example in which a user device 200 outputs release information to a user.

### DETAILED DESCRIPTION

The following example embodiments are combinations of components and features of various example embodiments in predetermined forms. Each component or feature may be considered as optional unless explicitly stated otherwise. Each component or feature may be implemented in a form that is not combined with other components or features. In addition, various example embodiments may be configured by combining some components and features. The order of operations described in various example embodiments may be changed. Some configurations or features of one example embodiment may be included in other example embodiments, or may be replaced with corresponding configurations or features of other example embodiments.

In describing the drawings, descriptions of procedures or steps that may obscure the gist of various example embodiments are not described, and procedures or steps that are understandable at the level of those skilled in the art are not described either.

Throughout the specification, when it is stated that a part “comprises” or “includes” a certain component, it means that other components may further be included, and it does not preclude other components, unless otherwise stated. In addition, terms such as “ . . . part”, “ . . . unit”, “ . . . module” described in the specification mean a unit for performing at least one function or operation, which may be implemented as hardware or software, or as a combination of hardware and software. In addition, “a”, “an”, “one”, “the” and similar related terms are used herein in a sense encompassing both the singular and the plural in the context of describing various example embodiments (especially in the context of the following claims) unless otherwise indicated or clearly contradicted by context.

Hereinafter, preferred implementations according to various example embodiments will be described in detail with reference to the accompanying drawings. The detailed description to be disclosed below with the accompanying drawings is intended to describe exemplary implementations of various example embodiments, and is not intended to represent the only implementation.

In addition, specific terms used in various example embodiments are provided to aid understanding of various example embodiments, and the use of these specific terms may be changed in other forms without departing from the technical spirit of the various example embodiments.

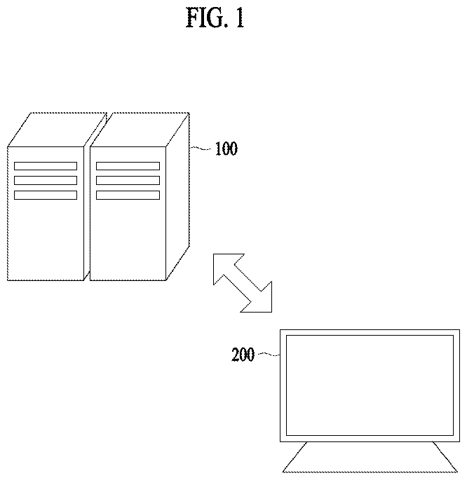

FIG. 1 is a diagram illustrating an order information management system in which an operating method of an electronic apparatus for managing order information according to various example embodiments may be implemented.

Referring to FIG. 1, the order information management system according to various example embodiments may be implemented in various types of electronic apparatuses. For example, the order information management system may be implemented in a server device 100 and a user device 200. In other words, the server device 100 and the user device 200 may perform operations according to various example embodiments of the present disclosure, based on the order information management system implemented in each device. On the other hand, the order information management system according to various example embodiments may be implemented in more various electronic apparatuses and servers rather than limited to those shown in FIG. 1.

The server device 100 according to various example embodiments may be an apparatus that performs wireless and wired communication with a plurality of user devices 200 and includes a storage with a large storage capacity. For example, the server device 100 may be a cloud device that works with a plurality of user devices.

The user device 200 according to various example embodiments may be a device that can be used by an individual user, such as a desktop PC, a tablet PC, or a mobile terminal. In addition, other electronic apparatuses performing similar functions may be used as the user device 200.

The order information management system according to various example embodiments may include various modules for operation. Modules included in the order information management system may be computer codes or one or more instructions implemented to cause a physical apparatus (for example, the server device 100 and the user device 200) on which the order information management system is implemented (or included in a physical apparatus) to perform a specified operation. In other words, the physical apparatus on which the order information management system stores a plurality of modules in a memory in the form of computer codes, and, when the plurality of modules stored in the memory are executed, the plurality of modules may cause the physical apparatus to perform specific operations corresponding to the plurality of modules.

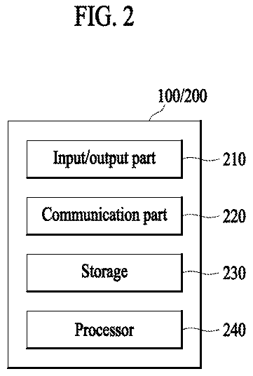

FIG. 2 is a diagram illustrating configurations of a server device and a user device according to various example embodiments.

Referring to FIG. 2, the server device 100 and the user device 200 may include an input/output part 210, a communication part 220, a storage 230, and a processor 240.

The input/output part 210 may be various interfaces or connection ports that receive a user input or output information to a user. The input/output part 210 may include an input module and an output module, and the input module receives the user input from the user. The user input may be made in various forms, including a key input, touch input, and voice input. Examples of the input module that can receive such user inputs include a traditional keypad, keyboard, and mouse, as well as a touch sensor that detects a user's touch, a microphone that receives a voice signal, a camera that recognizes gestures through image recognition, proximity sensors including at least one of an illuminance sensor or infrared sensor that detects a user approach, a motion sensor that recognizes a user motion through an acceleration sensor or a gyro sensor, and other input means of various types that detect or receive a user input of various other types, and the input module according to the example embodiment of the present disclosure may include at least one of the apparatuses listed above. Here, the touch sensor may be implemented as a piezoelectric or capacitive touch sensor that senses a touch through a touch panel or a touch film attached to a display panel, an optical touch sensor that senses a touch by an optical method, or the like. In addition, the input module may be implemented in the form of an input interface (USB port, PS/2 port, etc.) that connects an external input apparatus that receives a user input instead of an apparatus that detects a user input by itself. Also, the output module can output various types of information. The output module may include at least one of a display that outputs an image, a speaker that outputs sound, a haptic device that generates vibration, or other various types of output means. In addition, the output module may be implemented in the form of a port-type output interface for connecting the individual output means described above.

As an example, the output module in the form of a display may display text, still images, and moving pictures. The display may include at least one of a liquid crystal display (LCD), a light emitting diode (LED) display, an organic light emitting diode (OLED) display, a flat panel display (FPD), a transparent display, a curved display, a flexible display, a 3D display, a holographic display, a projector, or other various types of apparatuses that can perform image output functions. Such a display may be in the form of a touch display integrated with the touch sensor of the input module.

The communication part 220 may communicate with other apparatuses. Accordingly, the server device 100 and the user device 200 may transmit and receive information to and from other apparatuses through the communication part. For example, the server device 100 and the user device 200 may communicate with each other using the communication part or may communicate with other apparatuses.

Here, communication, that is, data transmission/reception may be performed by wire or wirelessly. To this end, the communication part may be composed of a wired communication module, a mobile communication module that connects to a mobile communication network through a mobile communication base station to transmit and receive data, a short-range communication module that uses a wireless local area network (WLAN) communication method such as Wi-Fi or a wireless personal area network (WPAN) communication method such as Bluetooth and Zigbee, a satellite communication module using Global Navigation Satellite System (GNSS) such as Global Positioning System (GPS), or a combination thereof.

The storage 230 may store various types of information. The storage can store data temporarily or semi-permanently. For example, in the storage of the server 100, an operating system (OS) for driving the server 100, data for hosting a website, a program for generating braille, data about the application (for example, web application), and so on may be stored. In addition, the storage may store modules in the form of computer codes as described above.

Examples of the storage 230 include a hard disk drive (HDD), a solid state drive (SSD), a flash memory, a read-only memory (ROM), a random access memory (RAM), and so on. Such a storage may be provided as a built-in type or a detachable type.

The processor 240 controls the overall operation of the server device 100 and the user device 200. To this end, the processor 240 may perform calculations and processing of various types of information and control operations of components of the server 100. For example, the processor 240 may execute a program or an application for managing order information. The processor 240 may be implemented as a computer or a similar apparatus according to hardware, software, or a combination thereof. In hardware, the processor 240 may be implemented in the form of an electronic circuit that performs a control function by processing an electrical signal, and in software, it may be implemented in the form of a program that drives the hardware processor 240. On the other hand, in the following description, if there is no special mention, the operation of the server device 100 and the user device 200 may be interpreted as being performed under the control of the processor 240. That is, when the modules implemented in the above-described order information management system are executed, the modules may be interpreted as controlling the processor 240 to cause the server device 100 and the user device 200 to perform the following operations.

In summary, various example embodiments can be implemented through various means. For example, various example embodiments may be implemented by hardware, firmware, software, or a combination thereof.

In the case of hardware implementation, methods according to various example embodiments can be implemented by one or more of application specific integrated circuits (ASICs), digital signal processors (DSPs), digital signal processing devices (DSPDs), programmable logic devices (PLDs), and field programmable gate arrays (FPGAs), processors, controllers, microcontrollers, microprocessors, and the like.

In the case of implementation by firmware or software, the method according to various example embodiments may be implemented in the form of a module, procedure, or function that performs features or operations described below. For example, the software code may be stored in a memory and driven by a processor. The memory may be located inside or outside the processor, and may exchange data with the processor through various known means.

Hereinafter, various example embodiments will be described in more detail based on the above technical idea. For various example embodiments described below, the above-described contents may be applied. For example, operations, functions, terms, or the like that are not defined in various example embodiments described below may be performed and described based on the above-described contents.

In the following description, various example embodiments will be described on the premise that a server device 100 performs an order information management operation. According to various example embodiments, a user device 200 that has obtained order information from the server device 100 may output the order information.

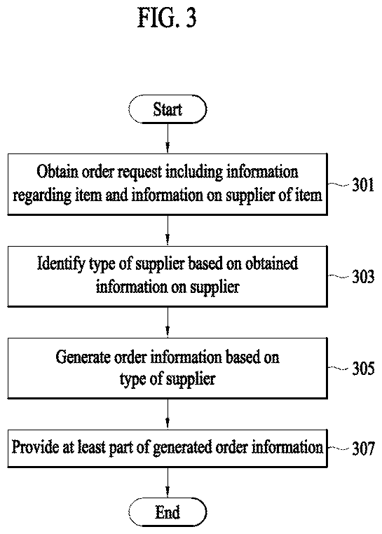

FIG. 3 is a diagram illustrating an operating method of an electronic apparatus for managing order information according to various example embodiments.

According to various example embodiments, in operation 301, the server device 100 may obtain an order request including information on an item and information on a supplier of the item.

For example, the server device 100 may receive or obtain an order request input by a user through the user device 200.

For example, the information on the item may include information for identifying the item subject to an order request, and information related to an order for the item, such as a quantity and price for supplying the item.

For example, the information on the supplier may be information on a company that supplies the item subject to an order request.

For example, the information on the supplier may be used by the server device 100 to determine the type of the supplier according to operation 303.

According to various example embodiments, in operation 303, the server device 100 may identify the type of the supplier based on the obtained information on the supplier.

For example, the type of the supplier may be classified according to the business operator that the supplier deals with for the supply of items. Specifically, the business operator that the supplier deals with for the supply of items may be a first business operator that provides a specific service through the server device 100 or by managing the server device 100 or a second business operator that manages the supply of items related to the service for the first business operator providing the specific service as described above.

In other words, the type of the supplier can be determined depending on whether the supplier deals with the first business operator providing the service for supply of the item and directly supplies with the item or the supplier supplies the first business operator with the item through the second business operator that manages the supply for the first business operator. As an example, the type of supplier may be classified into a first type in which a supplier deals with the first business operator providing the service and directly supplies with the item and a second type in which the supplier supplies the first business operator with the item through the second business operator that manages the supply for the first business operator.

For example, if the supplier corresponds to the first type, the server device 100 only needs to obtain the information of the supplier for the supply of the item. Therefore, the information on the supplier in operation 301 may only include information identifying the supplier.

For example, if the supplier corresponds to the second type, the server device 100 needs to obtain the information of the supplier and the business operator that manages the supply, that is, the above second business operator as well, for the supply of the item. Therefore, the information on the supplier in operation 301 may include both information identifying the corresponding supplier and information identifying the second business operator associated with the supplier. Alternatively, the server device 100 may obtain the information on the second business operator in advance, and may store a relationship between the supplier and the second business operator and refer to this to identify the second business operator based on the identification information of the supplier.

For example, when a supplier corresponds to the second type, the items supplied by the supplier to the second business operator and the quantity of items and the items supplied by the second business operator to the first business operator and the quantity of items may be the same.

For example, order information generated according to operation 305 to be described later by the server device 100 may vary based on the type of the supplier.

According to various example embodiments, in operation 305, the server device 100 may generate order information based on the type of supplier.

For example, the generated order information may vary depending on the type of supplier identified by the server device 100 in operation 303.

For example, the type of the supplier can be determined depending on whether the supplier deals with the first business operator providing the service for supply of the item and directly supplies with the item or the supplier supplies the first business operator with the item through the second business operator that manages the supply for the first business operator. As an example, the type of supplier may be classified into a first type in which a supplier deals with the first business operator providing the service and directly supplies with the item and a second type in which the supplier supplies the first business operator with the item through the second business operator that manages the supply for the first business operator.

Specifically, when a supplier corresponds to the first type, the server device 100 may generate first order information for the supplier and the first business operator. Alternatively, when a supplier corresponds to the second type, the server device 100 may generate second order information for the supplier and the second business operator and third order information for the second business operator and the first business operator.

At this time, when the supplier corresponds to the first type, the first order information generated by the server device 100 according to operation 305 includes information related to an order for supplying an item from the supplier to the first business operator.

As an example, the information related to the order for supplying the item from the supplier to the first business operator included in the first order information may include information for identifying the supplier that supplies with the item and information for identifying the first business operator that receives the item. Here, depending on the type of item to be supplied, one first business operator may be linked or correspond to one or more suppliers, and the supplier who supplies with the item in FIG. 3 may be one of the one or more suppliers.

Alternatively, as an example, the information related to the order for supplying the item from the supplier to the first business operator included in the first order information may include information related to the order such as information for identifying the item to be supplied and information on the quantity and price of the item.

Alternatively, as an example, the information related to the order for supplying the item from the supplier to the first business operator included in the first order information may include information related to the order such as information on the supply date of the item and information on the fulfillment center for supply of the item.

In addition, at this time, when the supplier corresponds to the second type, the second order information and the third order information generated by the server device 100 according to operation 305 may include information related to an order for supplying the item from the supplier to the second business operator and information related to an order for supplying the item from the second business operator to the first business operator, respectively.

As an example, the information related to the order for supplying the item from the supplier to the second business operator included in the second order information may include information for identifying a supplier that supplies with the item and information for identifying the second business operator managing the supply of the item for the first business operator. Here, depending on the type of item to be supplied, one second business operator may be linked or correspond to one or more suppliers, and the supplier who supplies with the item in FIG. 3 may be one of the one or more suppliers.

In addition, the information related to the order for supplying the item from the second business operator to the first business operator included in the third order information may include information for identifying the second business operator managing the supply of the item for the first business operator and information for identifying the first business operator providing the service. Here, depending on the type of item to be supplied, one first business operator may be linked or correspond to one or more second business operators, and the second business operator who manages the supply of the item for the first business operator supplies with the item in FIG. 3 may be one of the one or more second business operators.

Alternatively, as an example, the information related to the order for supplying the item from the supplier to the second business operator included in the second order information may include information related to the order such as information for identifying the item to be supplied and information on the quantity and price of the item.

In addition, the information related to the order for supplying the item from the second business operator to the first business operator included in the third order information may include information related to the order such as information for identifying the item to be supplied and information on the quantity and price of the item.

Here, the information related to the order included in the second order information and the information related to the order included in the third order information may equally include the information for identifying the item and the information on the supply quantity of the item. That is, the item to be supplied and the quantity thereof included in the information related to the order included in the second order information and in the information related to the order included in the third order information may be the same. However, information on the supply price of the item included in the information related to the order included in the second order information and in the information related to the order included in the third order information, respectively, may be different from each other.

Alternatively, as an example, the information related to the order for supplying the item from the supplier to the second business operator included in the second order information may include information related to the order such as information on the supply date of the item and information on the fulfillment center for supply of the item.

In addition, the information related to the order for supplying the item from the second business operator to the first business operator included in the third order information may include information related to the order such as information on the supply date of the item and information on the fulfillment center for supply of the item.

For example, the second order information and the third order information generated when the supplier corresponds to the second type may include identification information allocated by the server device 100. At least some of the identification information allocated to the second order information and the third order information corresponding to each other may be the same, and the server device 100 and the user may manage each order information based on the identification information allocated as described above.

For example, the identification information for identifying the second order information and the identification information for identifying the third order information generated when the supplier corresponds to the second type may include the same order number for the item to be supplied. As an example, the same order number may correspond to at least some of the same information among the identification information allocated for the second order information and the third order information.

The second order information and the third order information are separate order information and can be distinguished through different identification information, but the second order information and the third order information have the same item to be supplied, so the same order number for the corresponding item may be shared. At this time, the second order information and the third order information may be distinguished through respective different identification numbers. That is, the second order information and the third order information include the same order number, but may be distinguished and managed through other identification information such as identification numbers.

For example, when the supplier corresponds to the second type, the second order information and the third order information generated according to operation 305 by the server device 100 may include information on the same storage location. Since the second order information and the third order information have the same item to be supplied and the item will be finally supplied for the first business operator, the second order information and the third order information may include the same information on the storage location to be supplied for the first business operator.

For example, when the supplier corresponds to the second type, the second order information and the third order information generated in operation 305 by the server device 100 may be linked to each other to confirm the order. If the second order information is identified and confirmed according to an input through the user device 200 of the supplier, the third order information related thereto may be automatically confirmed without a separate input.

According to various example embodiments, in operation 307, the server device 100 may provide at least part of the generated order information.

For example, the at least part of the order information provided by the server device 100 may be at least part of the first order information generated according to operation 305 by the server device 100 or at least part of the second order information and the third order information generated according to operation 305 by the server device 100.

For example, the at least part of the order information provided by the server device 100 according to operation 307 may be based on example embodiments of operations 301 to 305 of the server device 100.

At this time, it is obvious that various pieces of information provided by the server device 100 according to operation 307 may be combined in various forms and provided together through the server device 100.

The server device 100 according to FIG. 3 may perform an order information management operation as well as a release information management operation as part of the order information management operation. In the following description, various example embodiments will be described on the premise that the server device 100 performs a management operation on release information related to the order information. According to various example embodiments, the user device 200 that has obtained the release information from the server device 100 may output the release information.

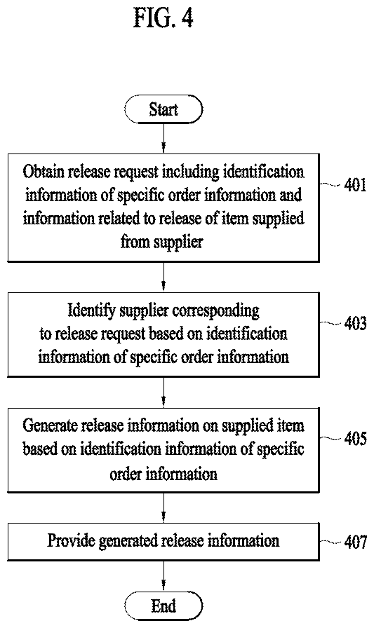

FIG. 4 is a diagram illustrating an operating method of an electronic apparatus for managing release information according to various example embodiments.

According to various example embodiments, in operation 401, the server device 100 may obtain a release request including identification information of specific order information and information related to release of an item supplied from a supplier.

For example, the specific order information may be the second order information or the third order information described in operation 305, and the identification information of the specific order information may be identification information for identifying the second order information or the third order information described in operation 305.

For example, the supplier may be the second type of supplier described in operation 305. That is, the supplier may be a company that supplies the first business operator with an item through the second business operator that manages supply to the first business operator.

For example, the information related to the release of the supplied item may include information related to the release of the item, such as information for identifying the item subject to the release request and the quantity and price for the release of the item.

For example, the server device 100 may receive or obtain a release request input by a user through the user device 200.

According to various example embodiments, in operation 403, the server device 100 may identify a supplier subject to release corresponding to the release request based on the identification information of the specific order information.

For example, the supplier subject to release corresponding to the release request may be a supplier of the second type described in operation 305. That is, the supplier subject to release may be a company that supplies items to the first business operator through a second business operator that manages supply for the first business operator.

For example, the supplier subject to release corresponding to the release request may be a company that has supplied the item included in specific order information, or may be a supplier corresponding to identification information of specific order information.

For example, the supplier subject to release corresponding to the release request may correspond to the supplier that supplies the item in FIG. 3.

According to various example embodiments, in operation 405, the server device 100 may generate release information for a supplied item based on identification information of specific order information.

For example, if the supplier subject to release corresponding to the release request is a supplier of the second type described in operation 305, the release information generated by the server device 100 in operation 405 may include first release information for releasing the supplied item from the first business operator to the second business operator and second release information for releasing the supplied item from the second business operator to the supplier subject to release.

At this time, when the supplier subject to release corresponds to the second type, the first release information and the second release information generated by the server device 100 in accordance with operation 405 may include information for releasing the item from the first business operator to the second business operator and information for releasing the item from the second business operator to the supplier subject to release.

As an example, the information for releasing the item from the first business operator to the second business operator included in the first release information may include information for identifying the first business operator and information for identifying the second business operator. In addition, the information for releasing the item from the second business operator to the supplier subject to release included in the second release information may include information for identifying the second business operator and information for identifying the supplier subject to release.

Alternatively, as an example, the information for releasing the item from the first business operator to the second business operator included in the first release information may include information related to the release such as information for identifying the item to be released and information on the release quantity and price of the item. In addition, the information for releasing the item from the second business operator to the supplier subject to release included in the second release information may include information related to the release such as information for identifying the item to be released and information on the release quantity and price of the item.

The information related to the release included in the first release information and the information related to the release included in the second release information may equally include the information for identifying the item and the information on the release quantity of the item. That is, the item to be released and the quantity thereof included in the information related to the release included in the first release information and in the information related to the release included in the second release information may be the same. However, information on the release price of the item included in the information related to the release included in the first release information and in the information related to the release included in the second release information, respectively, may be different from each other.

Alternatively, as an example, the information related to the release included in the first release information may include information related to the release such as information on the release date of the item and information on the fulfillment center for release of the item. In addition, the information related to the release included in the second order information may include information related to the release such as information on the release date of the item and information on the fulfillment center for release of the item.

For example, the identification information for identifying the first release information and the identification information for identifying the second release information may include the same release number for the item to be released.

That is, the first release information and the second release information are separate release information and can be distinguished through different identification information, but the first release information and the second release information have the same item to be released, so the same release number for the corresponding item may be shared. At this time, the first release information and the second release information may be distinguished through respective different identification numbers.

At this time, the release number identically included in the first release information and the second release information may correspond to the order number identically included in the second order information and the third order information described in operation 305.

For example, a type of reason for releasing an item included in the first release information and a type of reason for releasing an item included in the second release information may be different from each other. That is, even if the first release information and the second release information include information on the same item to be released, the types of reasons for release and specific reasons for release included in each release information may be different from each other.

According to various example embodiments, in operation 407, the server device 100 may provide the generated release information.

For example, the release information provided by the server device 100 may include the first release information and the second release information generated by the server device 100 in accordance with operation 405.

For example, the release information provided by the server device 100 according to the operation 407 may be based on example embodiments of the operations 301 to 307 and 401 to 405 of the server device 100.

At this time, it is obvious that various pieces of information provided by the server device 100 may be combined in various forms and provided together through the server device 100 according to operation 407.

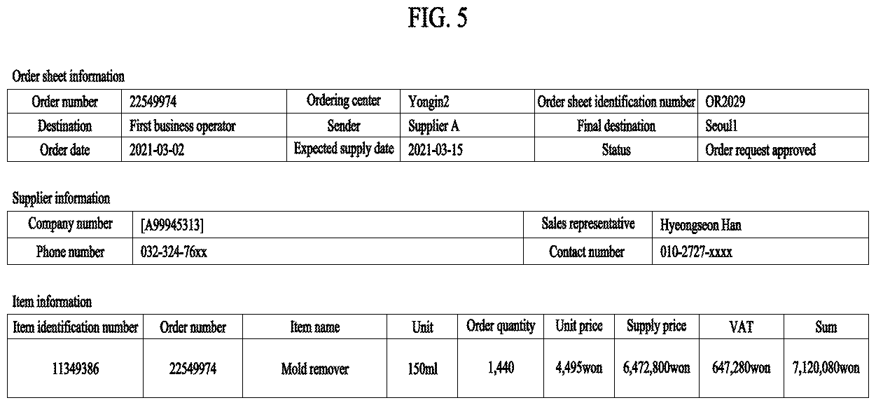

FIGS. 5 to 7 are diagrams illustrating examples of UI/UX (user interface/user experience) for order information management according to various example embodiments. For example, examples of FIGS. 5 to 7 may be UI/UX for a user device 200, and each example embodiment illustrated in the following drawings may be performed based on operations of the server device 100 illustrated above in FIGS. 3 to 4.

Specifically, each example embodiment of the UI/UX for the user device 200 described in the following drawings may be performed in the form that the user device 200 receives input information from a user and transmits it to the server device 100 and the server device 100 provides the user device 200 with information corresponding to the input information based on the operations described above in FIGS. 3 to 4 to output by the user device 200. However, each example embodiment of the UI/UX described in the drawings below is not limited to such a form, and may be performed in any form capable of implementing each example embodiment of the UI/UX.

FIG. 5 is a diagram illustrating an example in which a user device 200 outputs order information to a user based on an operation of a server device 100.

Referring to FIG. 5, the user device 200 may output one order information when a supplier directly supplies an item by dealing with a first business operator providing a service. In FIG. 5, the order information output by the user device 200 may include order sheet information on overall ordering, information on a supplier that supplies an item to be ordered, and information on the item.

The order sheet information may include an order number for ordering an item, an ordering center where the item is to be ordered, and information for identifying the order, and may include information on the destination and sender of the order, and information on the final destination of the item. In addition, order date, expected supply date, and information on progress of the order may also be included. The supplier information may include the identification number and contact information of the supplier who supplies the item, and information of the person in charge of item order of the supplier. Meanwhile, the item information may include information on an identification number, name, or unit for identifying the item, and information related to the order quantity and price of the item.

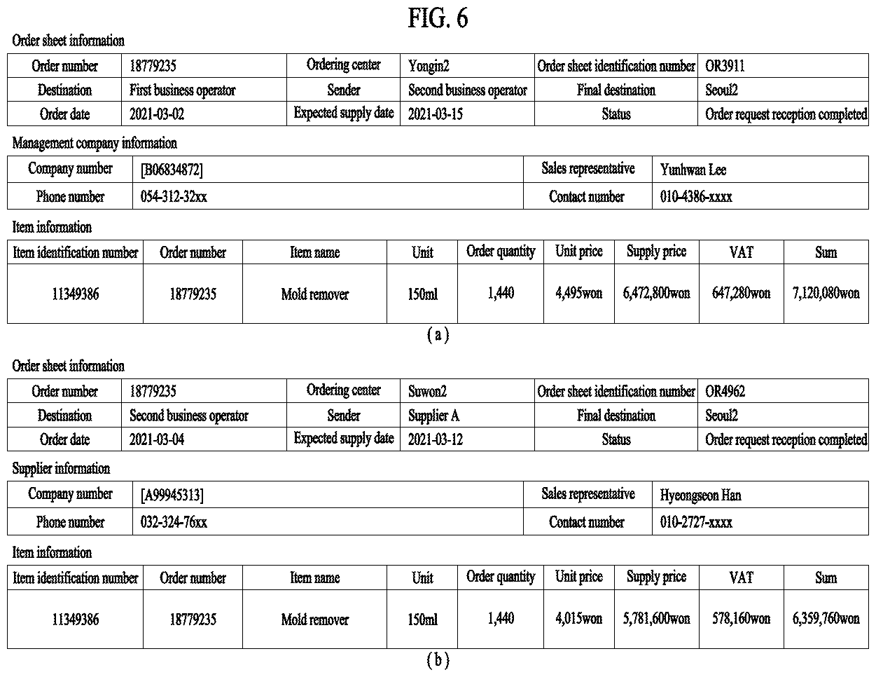

FIG. 6 is a diagram illustrating another example in which a user device 200 outputs order information to a user based on an operation of a server device 100.

Referring to (a) of FIG. 6, the user device 200 may output a plurality of order information when a supplier supplies an item to the first business operator through the second business operator that manages supply for the first business operator providing service.

In (a) of FIG. 6, the user device 200 may output order information for the first business operator providing service and the second business operator that manages supply for the first business operator. The order information output by the user device 200 may include order sheet information on overall ordering, information on a management company that manages supply of items to be ordered, that is, the second business operator, and information on the item.

The order sheet information may include an order number for ordering an item, an ordering center where the item is to be ordered, and information for identifying the order, and may include information on the destination and sender of the order, and information on the final destination of the item. In addition, order date, expected supply date, and information on progress of the order may also be included. The management company information may include the identification number and contact information of the management company that manages the supply of the item, and information of the person in charge of item order of the management company. Meanwhile, the item information may include information on an identification number, name, or unit for identifying the item, and information related to the order quantity and price of the item.

In (b) of FIG. 6, the user device 200 may output order information for the second business operator that manages supply for the first business operator providing service and the supplier that supplies the item. The order information output by the user device 200 may include order sheet information on overall ordering, information on the supplier that supplies the item to be ordered, and information on the item.

The order sheet information may include an order number for ordering an item, an ordering center where the item is to be ordered, and information for identifying the order, and may include information on the destination and sender of the order, and information on the final destination of the item. In addition, order date, expected supply date, and information on progress of the order may also be included. The supplier information may include the identification number and contact information of the supplier who supplies the item, and information of the person in charge of item order of the supplier. Meanwhile, the item information may include information on an identification number, name, or unit for identifying the item, and information related to the order quantity and price of the item.

At this time, the order information output by the user device 200 in (a) of FIG. 6 and the order information output by the user device 200 in (b) of FIG. 6 are identified by different order sheet identification numbers, but may contain the same order number for the same item. That is, the server device 100 may manage two order information for the same item with single and the same order number to output through the user device 200. In addition, the two order information deal with the orders of the same item and include the same information on the final destination of the item, but may include different information about the order date, expected supply date, or price, which are directly related to the order or supply of the item.

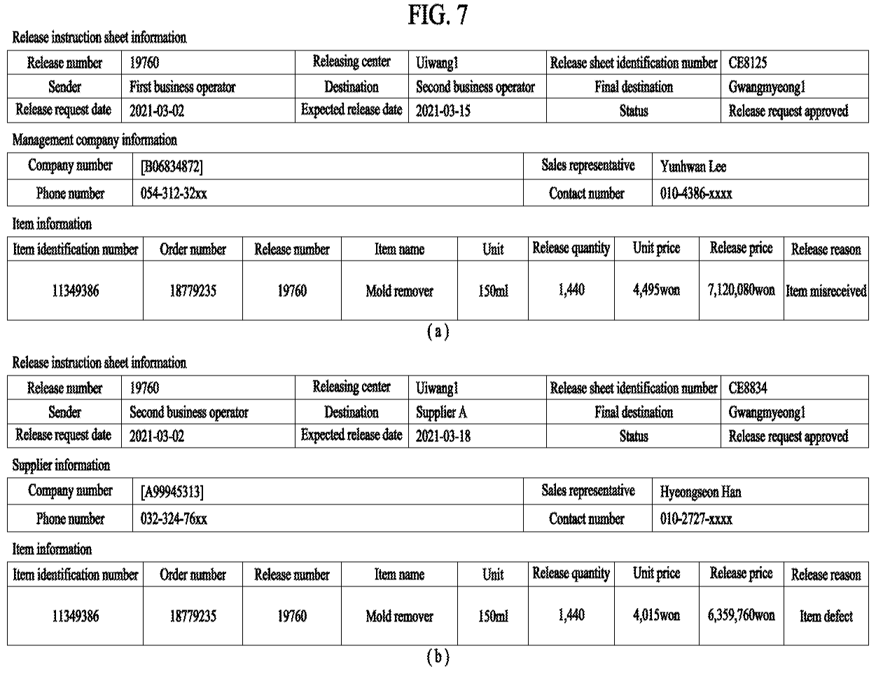

FIG. 7 is a diagram illustrating an example in which a user device 200 outputs release information to a user based on an operation of a server device 100.

Referring to FIG. 7, the user device 200 may output a plurality of release information when a release request is obtained in a situation in which a supplier supplies an item to the first business operator through the second business operator that manages supply for the first business operator providing service.

In (a) of FIG. 7, the user device 200 may output release information for the first business operator providing service and the second business operator that manages supply for the first business operator. The release information output by the user device 200 may include release instruction sheet information on overall release, information on a management company that manages release of items, that is, the second business operator, and information on the item.

The release instruction sheet information may include a release number for releasing an item, a releasing center where the item is to be released, and information for identifying the release instruction sheet, and may include information on the destination and sender of the release, and information on the final destination of the item. In addition, release request date, expected release date, and information on progress of the release may also be included. The management company information may include the identification number and contact information of the management company that manages the release of the item, and information of the person in charge of item release of the management company. Meanwhile, the item information may include information on an identification number, name, or unit for identifying the item, information related to the release quantity and price of the item and reasons for release.

In (b) of FIG. 7, the user device 200 may output release information for the second business operator that manages supply for the first business operator providing service and the supplier subject to item release. The release information output by the user device 200 may include release instruction sheet information on overall release, information on the supplier subject to item release, and information on the item.

The release instruction sheet information may include a release number for releasing an item, a releasing center where the item is to be released, and information on progress of the release, and may include information on the destination and sender of the release, and information on the final destination of the item. In addition, release request date, expected release date, and information on progress of the release may also be included. The supplier information may include the identification number and contact information of the supplier subject to item release, and information of the person in charge of item release of the management company. Meanwhile, the item information may include information on an identification number, name, or unit for identifying the item, information related to the release quantity and price of the item and reasons for release.

At this time, the release information output by the user device 200 in (a) of FIG. 7 and the release information output by the user device 200 in (b) of FIG. 7 are identified by different release instruction sheet identification numbers, but may contain the same release number for the same item. That is, the server device 100 may manage two release information for the same item with single and the same release number to output through the user device 200. In particular, the same release number may correspond to the same single order number assigned for placing an order for the item. In addition, the two release information deal with the releases of the same item and include the same information on the final destination of the item, but may include different information about the release request date, expected release date, price, or reasons for release, which are directly related to the release of the item.

The UI/UX for the user device 200 of FIGS. 5 to 7 and the operation of the user device 200 may be performed in association with the operation of the server device 100 described above in FIGS. 3 to 4. The UI/UX illustrations of FIGS. 5 to 7 are examples to exhibit the present disclosure, and various example embodiments of the present disclosure are not limited to the UI/UX forms of FIGS. 5 to 7 and can be performed according to all forms of UI/UX capable of implementing various example embodiments of the present disclosure.

The example embodiments of the present disclosure described in the present specification and drawings are only provided as specific examples to easily explain the technical content of the present disclosure and to aid understanding of the present disclosure, but are not intended to limit the scope of the present disclosure. That is, it is apparent to those of ordinary skill in the art that other modifications based on the technical idea of the present disclosure can be implemented. In addition, each of the above example embodiments may be combined and operated, as necessary. For example, all example embodiments of the present disclosure may be implemented by combining parts thereof with each other by a system.

In addition, the method according to the system and the like according to the present disclosure may be implemented in the form of program instructions that can be executed through various computer means and recorded in a computer-readable medium.

As described above, various example embodiments of the present disclosure may be implemented as computer readable code in a computer readable recording medium from a specific viewpoint. A computer readable recording medium is any data storage device capable of storing data that can be read by a computer system. Examples of computer readable recording media include read only memory (ROM), random access memory (RAM), and compact disk-read only memory (CD-ROM), magnetic tapes, floppy disks, optical data storage devices, and carrier waves (such as data transmission over the Internet). The computer readable recording medium can also be distributed through networked computer systems, so that the computer readable code is stored and executed in a distributed manner. In addition, functional programs, codes, and code segments for achieving various example embodiments of the present disclosure can be easily interpreted by skilled programmers in the field to which the present disclosure is applied.

In addition, it will be appreciated that the apparatus and method according to various example embodiments of the present disclosure can be realized in the form of hardware, software, or a combination of hardware and software. Such software may be stored in a storage medium that can be optically or magnetically recordable and readable by a machine (for example, a computer) as well, for example, regardless of whether it is erasable or rewritable, a volatile or nonvolatile storage device such as a storage device such as a ROM, or, for example, a memory such as a RAM, a memory chip, or an integrated circuit, or, for example, compact disk (CD), DVD, magnetic disk, or magnetic tape. The method according to various example embodiments of the present disclosure may be implemented by a computer including a controller and a memory, or a vehicle including such a memory or a computer, and it would be appreciated that such a memory is an example of a machine readable storage medium suitable for storing a program or programs including instructions for implementing the example embodiments of the present disclosure.

Accordingly, the present disclosure includes a program including a code for implementing the apparatus or method described in the claims of the present specification and a storage medium readable by a machine (such as a computer) storing such a program. Further, such a program may be transferred electronically through any medium, such as a communication signal transmitted through a wired or wireless connection, and the present disclosure suitably includes equivalents thereto.

Although the above has been described with reference to the example embodiments of the present disclosure, the example embodiments of the present disclosure disclosed in the present specification and drawings are only intended to provide specific examples in order to easily describe the technical content of the present disclosure and to aid understanding of the present disclosure but not intended to limit the scope of the present disclosure. In addition, the example embodiments of the present disclosure described above are merely exemplary, and those of ordinary skill in the art will understand that various modifications and example embodiments of equivalent ranges are possible therefrom. Accordingly, the true technical protection scope of the present disclosure should be determined by the following claims.

1. A method of managing order information by an electronic apparatus, the method comprising:
obtaining an order request comprising information regarding an item and information on a supplier of the item wherein the order request is obtained from an electronic commerce (e-commerce) service provided via a first business operator managing the electronic apparatus;
identifying a type of the supplier based on the information on the supplier;
generating, in response to the obtaining of the order request, order information comprising:
when the type of the supplier is a first type that directly supplies the item to the first business operator, first order information for supplying the item from the supplier to the first business operator; and
when the type of the supplier is a second type that supplies the item to the first business operator via a second business operator managing supplying of the item for the first business operator, second order information for supplying the item from the supplier to the second business operator and third order information for supplying the item from the second business operator to the first business operator, wherein identification information of the second order information and identification information of the third order information include a shared order number configured based on the second and the third order information being determined to include a same identification number of the item;
providing at least part of the generated order information,
obtaining a release request comprising (a) information indicative of the supplier being of the second type and (b) information regarding the item supplied by the supplier;
generating, based on the information regarding the item, (a) first release information for releasing the item from the first business operator to the second business operator and (b) second release information for releasing the item from the second business operator to the supplier, wherein the first release information and the second release information include a shared release number corresponding to the shared order number based on the first and the second release information being related to the second and the third order information, wherein the shared release number is configured based on the first and the second release information being determined to include the same identification number of the item and the shared order number;
providing the first release information and the second release information to a first user computing device of the first business operator, a second user computing device of the second business operator, and a third user computing device of the supplier;
causing, by a user interface of each user device, the first release information and the second release information to be displayed on each of the first user computing device, the second user computing device, and the third user computing device;
releasing, by the second business operator, the item from the supplier based on the second release information; and
releasing, by the first business operator, the item from the second business operator based on the first release information.

2. (canceled)

3. The method of claim 1, wherein an identification number included in the identification information of the second order information and an identification number included in the identification information of the third order information are different.

4. The method of claim 1, wherein information on a storage location of the item included in the second order information and information on a storage location of the item included in the third order information are the same.

5. The method of claim 1, wherein the generated order information comprises information on a supply date of the item and information on a fulfillment center for supplying the item.

6. (canceled)

7. The method of claim 1, wherein, when the type of the supplier is the second type, the information on the supplier comprises information on the second business operator.

8. The method of claim 1, wherein:
the second order information comprises information on a price at which the item is supplied from the supplier to the second business operator; and
the third order information comprises information on a price at which the item is supplied from the second business operator to the first business operator.

9. The method of claim 1, wherein the information on the item is included in both the second order information and the third order information.

10. The method of claim 1, wherein the third order information is confirmed when the second order information is confirmed by a first input of the supplier corresponding to the second order information.

11-13. (canceled)

14. The method of claim 1, wherein release reason information for the supplied item included in the first release information and release reason information for the supplied item included in the second release information are different.

15. An electronic apparatus for managing order information, the electronic apparatus comprising:
a processor; and
one or more memories storing one or more instructions, wherein the one or more instructions, when executed, cause the processor to perform steps comprising:
obtaining an order request comprising information on an item and information on a supplier of the item wherein the order request is obtained from an electronic commerce (e-commerce) service provided via a first business operator managing the electronic apparatus;
identifying a type of the supplier based on the information on the supplier;
generating, in response to the obtaining of the order request, order information comprising:
when the type of the supplier is a first type that directly supplies the item to the first business operator, first order information for supplying the item from the supplier to the first business operator; and
when the type of the supplier is a second type that supplies the item to the first business operator via a second business operator managing supplying of the item for the first business operator, second order information for supplying the item from the supplier to the second business operator and third order information for supplying the item from the second business operator to the first business operator, wherein identification information of the second order information and identification information of the third order information include a shared order number configured based on the second and the third order information being determined to include a same identification number of the item;
providing at least part of the generated order information,
obtaining a release request comprising (a) information indicative of the supplier being of the second type and (b) information regarding the item supplied by the supplier;
generating, based on the information regarding the item, (a) first release information for releasing the item from the first business operator to the second business operator and (b) second release information for releasing the item from the second business operator to the supplier, wherein the first release information and the second release information include a shared release number corresponding to the shared order number based on the first and the second release information being related to the second and the third order information, wherein the shared release number is configured based on the first and the second release information being determined to include the same identification number of the item and the shared order number;
providing the first release information and the second release information to a first user computing device of the first business operator, a second user computing device of the second business operator, and a third user computing device of the supplier;
causing, by a user interface of each user device, the first release information and the second release information to be displayed on each of the first user computing device, the second user computing device, and the third user computing device;
releasing, by the second business operator, the item from the supplier based on the second release information; and
releasing, by the first business operator, the item from the second business operator based on the first release information.

16. (canceled)
